(19) United States
(12) Patent Application Publication
(10) Pub. No.: US 2017/0181585 A1
(43) Pub. Date: Jun. 29, 2017

(54) CLEANSING DEVICE HAVING ADDITIVE COMPOSITIONS DISPOSED IN A CARRIER

(71) Applicant: The Dial Corporation, Scottsdale, AZ (US)

(72) Inventors: Dan Khamis, Phoenix, AZ (US); Mary J. Conway, Phoenix, AZ (US)

(21) Appl. No.: 14/982,240

(22) Filed: Dec. 29, 2015

(51) Int. Cl. A47K 7/03; C11D 17/04

(52) U.S. Cl. CPC A47K 7/03; C11D 17/041

(57) ABSTRACT

A cleansing device is described. The cleansing device includes a carrier. The carrier has at least one cavity defined therein. The at least one cavity is to receive at least one additive composition and to maintain the at least one additive composition. The additive composition is to be applied to a surface. The device also includes a housing that holds the carrier and at least one additive composition during application of the additive composition to the surface.

### FIELD OF THE INVENTION

The present invention generally relates to a cleansing device that includes a carrier to receive additive compositions, and more particularly relates to a cleansing device with a carrier that receives personal care additive compositions to be applied to a surface such as skin.

### BACKGROUND OF THE INVENTION

Humans have been making cleansing compositions since the times of ancient Babylon. In the almost five millennia since humans started making cleansing compositions, the compositions have taken a variety of forms, including both solid and liquid cleansing compositions. Such compositions are a regular part of many people's lives and in some cases are used on non-humans, such as animals. Compositions can be manufactured to perform a variety of functions. Specifically the different ingredients within a composition perform different functions. For example a composition may have ingredients that cleanse, remove odor, treat skin blemishes such as acne, moisturize the skin, prevent bacterial growth, and provide fragrance to the skin.

With such a wide variety of users having different skin types, the needs of distinct users may be different. For example, one individual may have dry skin and therefore may use a composition with an enhanced moisturizing property. A different individual that has acne or other skin blemishes would prefer a composition with an acne prevention or reduction property.

Accordingly, it is desirable to have a cleansing device that accommodates the different users and skin types that may use the cleansing device. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A cleansing device is described. The device includes a carrier having at least one cavity defined therein. The at least one cavity is to receive and maintain at least one additive composition. The at least one additive composition is to be applied to a surface. The device also includes a housing to hold the carrier, with the at least one additive composition disposed therein, during deposition of the additive composition to the surface.

The present application also describes a cleansing system. The system includes a carrier having at least one cavity defined therein. The at least one cavity is to receive and maintain at least one additive composition. The system also includes at least one additive composition disposed within a cavity of the carrier. The additive is to be applied to a skin surface. The system further includes a housing to house the carrier and the at least one additive composition during application of the composition onto the skin surface.

The present application further describes a personal care product. The product includes a bar soap having multiple cavities defined therein. A cavity is to receive and maintain an additive personal care soap. The product also includes multiple additive personal care soaps. An additive personal care soap is disposed within a cavity of the bar soap and is to be applied to a skin surface. The product also includes a housing to retain the bar soap and the multiple additive personal care soaps during application of the additive personal care soaps to the skin surface.

### BRIEF DESCRIPTION OF THE DRAWINGS

The present invention will hereinafter be described in conjunction with the following drawing figures, wherein like numerals denote like elements, and

FIG. 1 is a diagram of an example of a carrier of the cleansing device according to the principles described herein.

FIG. 2 is a diagram of an example of additive compositions according to the principles described herein.

FIG. 3 is a diagram of an example of a cleaning system with additive compositions disposed in a carrier according to the principles described herein.

FIG. 4 is a diagram of an example of a housing to receive a carrier with additive compositions disposed therein according to the principles described herein.

FIG. 5 is a diagram of an example of a personal care product with additive personal care soaps disposed in a bar soap according to the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As described above, compositions, and personal care compositions in particular, are commonly used by most individuals, and in some cases used on other animals. Such compositions are applied regularly; every day for example and in some cases multiple times per day. With varying needs based on such factors as skin type, environmental conditions, and budget, the needs of the users are at least as varied as the number of users themselves. For example, some users with dry skin, or that live in a dry climate may prefer a composition that has enhanced moisturizing characteristics than may a person living in a humid climate. As another example, some individuals may prefer a particular fragrance, or strength of fragrance where another may not. Addressing the various needs of the various users can become quite expensive to a producer and is a very complex task.

Accordingly, the principles described herein provide a customizable cleansing device. The device includes a base carrier that has cavities defined therein. Each of the cavities is to receive an additive composition, which additive composition may be configured to perform any variety of personal care functions. For example, an additive composition may include ingredients to 1) provide additional moisturization, 2) prevent or reduce acne, 3) exfoliate skin, 4) provide additional fragrance, and 5) mask or prevent odor. This is just a sample of the different functions, or ingredients that could be included in such an additive composition. A user may select which additive compositions to place in the base carrier such that the cleansing device may be selected, and customized, by a user depending on their particular needs or desires.

In this fashion, a user can form a customizable cleansing composition that is tailored to their particular needs. This is also beneficial as a single composition, i.e., carrier with additives, may be used to deliver specific and customized personal care functions. This may be cheaper for a user as there is no need to buy multiple compositions, but a single composition with customizable additives. Such flexibility increases the ability of a manufacturer to meet the demands from the varied users with their various requirements. A composition that addresses the particular needs of a user is sure to create a satisfactory customer experience and could potentially result in increased profits for a producer of such a customized personal composition.

As used in the present specification and in the appended claims, the term “a number of” or similar language may include any positive number, including one to infinity; zero not being a number, but the absence of a number.

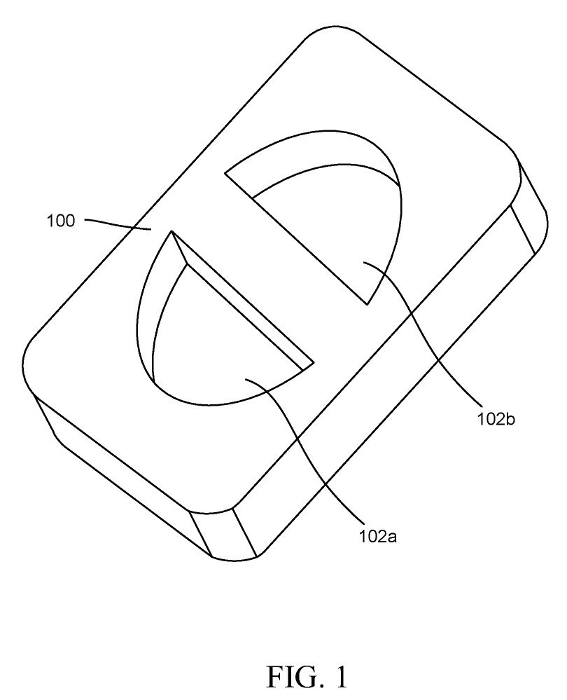

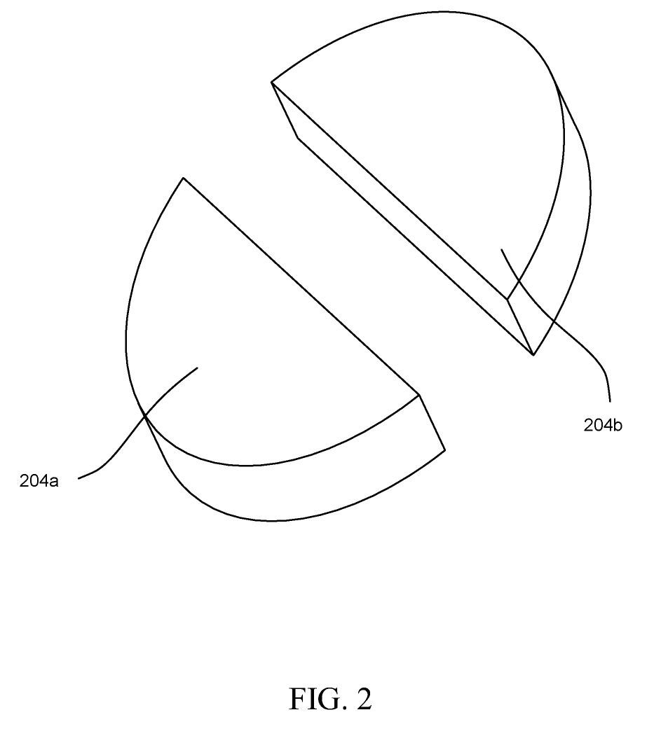

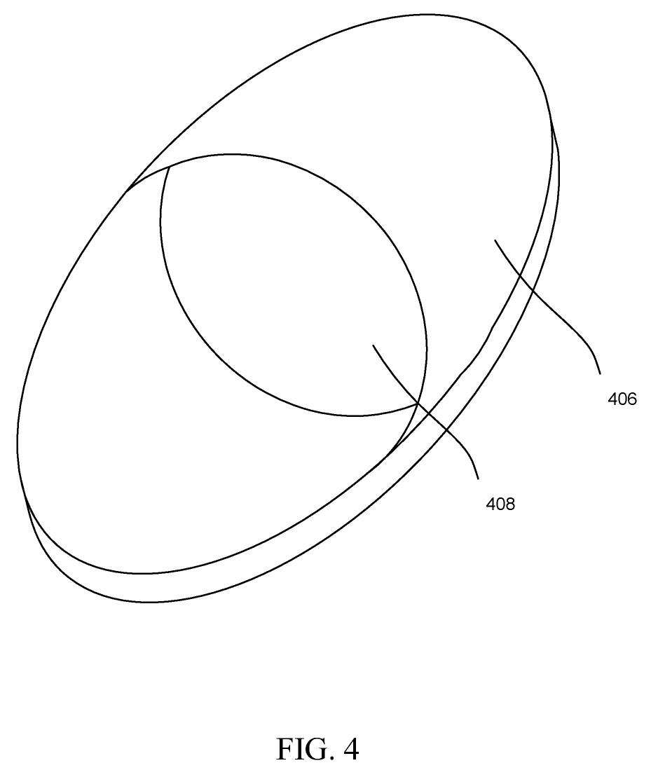

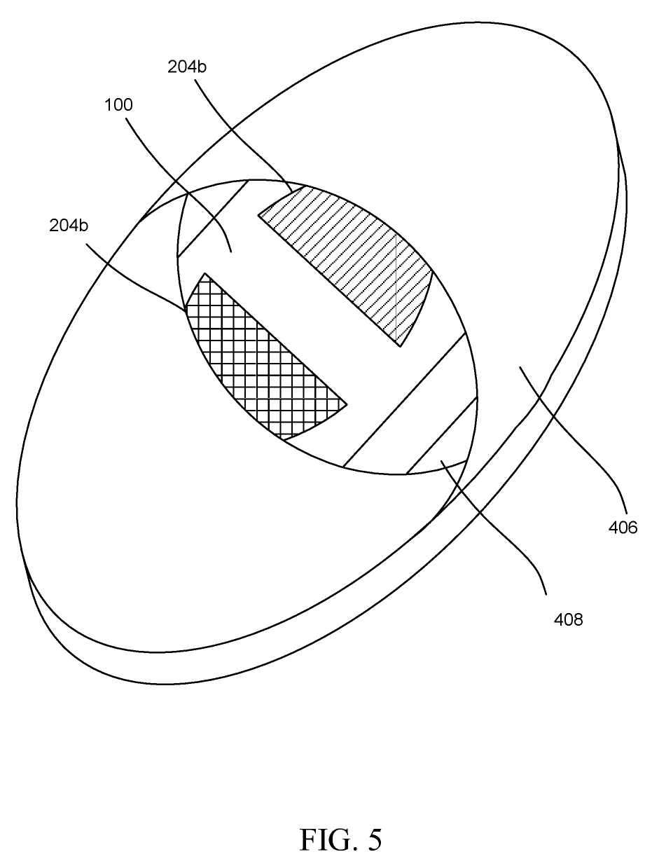

Turning now to the figures, FIG. 1 is a diagram of an example of a carrier (100) of the cleansing device according to the principles described herein. The carrier (100) houses the additive compositions that are described below in connection with FIG. 2. The carrier (100) is the vehicle by which a user applies the additive compositions to their skin. For example, the user grasps the carrier (100) in their hand and rubs the carrier over the skin surface. Accordingly, the carrier (100) may be sized to fit in the hand of a user. In another example, as described below in connection with FIGS. 4 and 5, the carrier (100) may be placed in a housing, which housing may be easier to grasp and may enhance the application of the cleansing component of the additive compositions onto the skin surface. During use, a friction force between the user's skin and the additive compositions or between the housing and the additive compositions dislodges particles from the compositions for deposition onto the skin. Additionally, when used in a wet environment such as a shower or a bath, the interaction with water also dislodges particles from the additive compositions and carrier (100) to be deposited on the skin surface.

The carrier (100) has at least one cavity (102) to receive the additive compositions, which additive compositions are to be applied to, and deposited on, a surface such as skin. As such, the cavities (102) are the same size and the same shape as the additive compositions that are to be deposited therein. While FIG. 1 depicts two cavities (102) of a particular size, shape, and orientation, the cavities (102) may be of any shape and size and placed anywhere on the carrier (100). For example, a first cavity (102a) may be placed on a front surface and a second cavity (102b) may be placed on an opposite surface. In this case, different additive compositions could be placed in either cavity (102) to provide different uses when different sides of the carrier (100) are exposed to skin.

Moreover, while FIG. 1 depicts a carrier (100) with two cavities (102a, 102b), the carrier (100) may have any number of cavities (102) to receive any number of additive compositions. For example, the carrier (100) may have multiple cavities (102) as indicated in FIG. 1, or the carrier (100) may have one cavity (102). In some examples, the cavities (102) may be through holes protruding through the carrier (100). Doing so may be beneficial as an inserted additive composition is exposed on at least two surfaces thus increasing the amount of composition available for deposition on a surface.

The carrier (100) may be formed of any material. For example, like the additive compositions, the carrier (100) may include skin care, or personal care, ingredients. For example, the carrier (100) may be a bar soap that includes some personal care ingredients. As used in the present specification and in the appended claims, the term ‘soap’ may refer to salts of fatty acids. During use an outer layer of the soap bar is removed and underneath layers are unaffected. In a soap form, the carrier (100) may include ingredients that cleanse the skin, or facilitate in the cleansing of skin. Such ingredients include a surfactant for cleansing or washing the skin, glycerol and a number of other additive ingredients.

The bar soap carrier (100) may be a semi-solid soap. A semi-solid soap is a soap that is not hard. In other words, the soap may be a soft solid. As a soft, semi-solid, or solid soap, the particles of the soap to not have sufficient inter-particulate cohesion to overcome the force of friction. In other words, as the soap carrier (100) is moved over a surface such as the skin, or that comes into contact with a housing which holds the soap carrier (100), the friction force between the surface (i.e., skin or the housing) and the soap is greater than the cohesive bonds between the particles of the soap such that those particles are deposited on the surface and then carry out their intended function, whether that function be a cleansing, exfoliating, moisturizing, or odor-reducing function, among others. Still further the interaction of the soap with water may also break down the bonds holding the individual soap particles together thus again resulting in the deposition of the soap carrier (100) particles on a skin surface.

In addition to those ingredients, the soap carrier (100) may include other ingredients to impart other functionality to the soap carrier (100). Such ingredients include a fragrance ingredient, exfoliating particles, and moisturizing ingredients among other personal care ingredients. In this example, the carrier (100), like the additive compositions, may carry out a personal care function when applied to skin. This additional skin maintenance is offered by a soap-like carrier (100).

In addition to the ingredients mentioned above, the soap carrier (100) may include other ingredients to improve the application aesthetics, contact aesthetics, or other characteristics of the soap carrier (100). For example, the soap carrier (100) may include a structurant. A structurant may be any compound or mixture configured to give shape, or structure to the soap carrier (100). Accordingly, the soap carrier (100) may include any compound or mixture that is configured to give shape, or structure to the soap carrier (100). Other examples of ingredients in the soap carrier (100) include an emollient, an anti-bacterial additive, a dye, an antioxidant, a skin conditioner, a pigment, and a preservative.

In other examples, the carrier (100) may be formed of a different material such as a silicon material, a rubber material, a foam material, and a sponge material. As described above a soap-type carrier (100) results in deposition of layers of the soap carrier (100) on the surface. However, with a silicon, rubber, plastic, foam, or sponge carrier (100), such deposition does not occur. Accordingly, the carrier (100) is reusable, even after the expiration of an inserted additive composition.

Using a carrier (100) that can facilitate different additive compositions is beneficial in that it allows a user to customize a cleansing device by selecting additive compositions that are relevant to that user. Such customization may reduce the cost of personal hygiene as a user can purchase a single base carrier and multiple additive compositions without having to purchase multiple full-size cleansing devices.

FIG. 2 is a diagram of an example of additive compositions (204) according to the principles described herein. As described above, additive compositions (204), which may be skin care compositions or personal care compositions are disposed in the cavities (FIG. 1, 102) of the carrier (FIG. 1, 100). The additive compositions (204) are the same shape and same size as the cavities (FIG. 1, 102) into which they are to be inserted. While FIG. 2 depicts an additive composition (204) of a particular size and shape, any size and shape of additive composition (204) can be used in line with the present application, so long as it fits the shape and size of the cavity (FIG. 1, 102), which cavity (FIG. 1, 102) also can be any size and shape.

The additive compositions (204) are used to provide various cleansing functions to a user. Accordingly, the additive compositions (204) may be of varying types, meaning the additive compositions (204) may serve different functions. Examples of types of additive compositions (204) a moisturizer composition, a lotion composition, an anti-bacterial composition, an acne treatment composition such as salycilic acid, a sun block composition, an exfoliating composition, a deodorizing composition, a shaving cream composition, a body wash composition, an anti-oxidant composition, and a fragrance composition. The anti-bacterial composition may be triclosan, triclocarban, benzalkonium chloride, and benzethonium chloride among others. Each additive composition (204) may perform one or more of these functions. For example, a single additive composition (204) may be a combination of 1) have a moisturizing enhancing composition and 2) a fragrance composition.

As with the carrier (FIG. 1, 100), the additive compositions (204) may be soaps. During use, particles of the soap to not have sufficient inter-particulate cohesion to overcome the force of friction. In other words, as the soap additive composition (204) is moved over a surface such as the skin, or a housing that the additive composition (204) is disposed within, the friction force between the surface and the soap is greater than the cohesive bonds between the particles of the soap such that those particles are deposited on the surface and then carry out their intended function, whether that function be a cleansing, exfoliating, moisturizing, or odor-reducing function, among others. Still further the interaction of the soap with water may also break down the bonds holding the individual soap particles together thus again resulting in the deposition of the soap particles on a skin surface.

In addition to including ingredients carrying out the above described functions, the additive composition (204) may include other ingredients to improve the application aesthetics, contact aesthetics, or other characteristics of the additive composition (204). For example, the additive composition (204) may include a structurant. A structurant may be any compound or mixture configured to give shape, or structure to the additive composition (204). Accordingly, the additive composition (204) may include any compound or mixture that is configured to give shape, or structure to the additive composition (204). Other examples of ingredients in the additive composition (204) include an emollient, an anti-bacterial additive, a dye, an antioxidant, a skin conditioner, a pigment, and a preservative.

In some examples, different additive compositions (204) have different colors. For example, a first additive composition (204a) which may include an ingredient to prevent acne such as salycilic acid may be red color while a second additive composition (204b) which may include an extra moisturizer may be a blue color. Doing so may enable a user to more easily identify the purpose, or function, of a particular additive composition (204).

Producing different additive compositions (204) may be beneficial to a user by providing a number of different skin care compounds that a user can select and tailor to their preference. For example, a user with dry skin and that is prone to acne can select additives that provide an extra moisturizing ingredient and an acne prevention ingredient respectively. Such customization via additive compositions (204) placed in a carrier (FIG. 1, 100) are unique in the field.

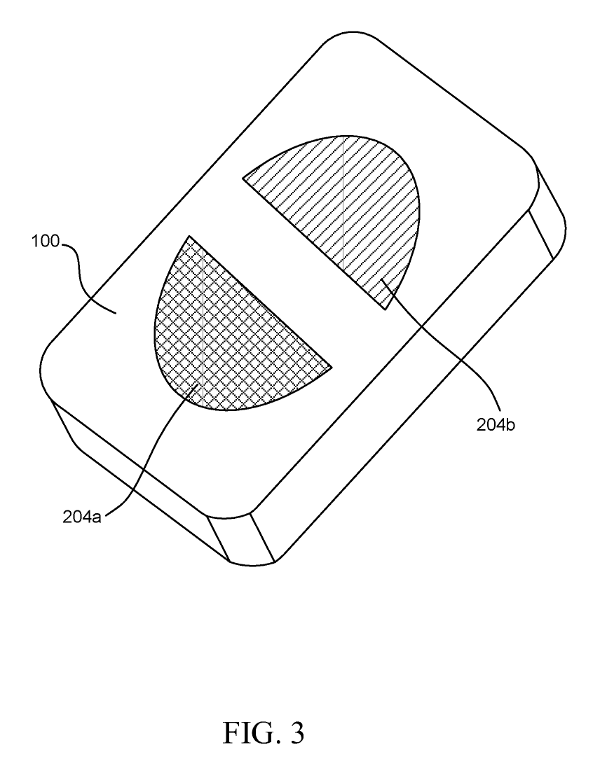

FIG. 3 is a diagram of an example of a cleaning system with additive compositions (204) disposed in a carrier (100) according to the principles described herein. As described above, the carrier (100) receives the additive compositions (204) such that the additive compositions (204) and the carrier (100). In other words, the cleaning system as described herein includes the carrier (100) having at least one cavity (FIG. 1, 102), and the additive compositions (204a, 204b) that are also disposed therein.

Note that the hashing of the additive compositions (204a, 204b) is not meant to impart any material properties to the additive compositions (204a, 204b), but is merely intended to distinguish between the different additive compositions (204) and the carrier (100). The different hashing on the different additive compositions (204) indicates different types, or different purposes served by, the different additive compositions (204). That is the carrier (100) has multiple cavities (FIG. 1, 102) that not only house multiple additive compositions (204), but that house different types of additive compositions (204). For example, the first additive composition (204a) may be an additional fragrance composition while the second additive composition (204b) may be an odor-eliminating composition, or an antiperspirant composition. While FIG. 2, specifically depicts different kinds of additive compositions (204) in the different cavities (FIG. 1, 102), the different cavities (FIG. 1, 102) may be filled with different instances of the same composition (204). For example, a user could put two moisturizing additive compositions (204) in the carrier (100), one in either cavity (FIG. 1, 102) thus providing an even further enhanced moisturizing benefit.

The additive compositions (204) may be press fit into the carrier (100) so as to be retained in the carrier (100). Moreover, as water particles interact with the additive compositions (204) as well as with a non-synthetic carrier (100), the particles of the additive compositions (204) and non-synthetic carrier (100) may fuse to retain the additive compositions (204) in the carrier (100). Doing so may be beneficial for improving the efficacy of the cleansing system. For example, if the additive composition (204) falls out of the carrier (100), a user may become frustrated by continually having to re-position the additive composition (204) within the carrier (100).

When joined as depicted in FIG. 3, the system is ready for use by placement within the housing described in FIG. 4. As noted above, both the additive composition (204) and a soap-like carrier (100) may include personal care ingredients such as a surfactant for cleansing the skin, a moisturizer, a lotion, an antibacterial ingredient, an acne treatment, a sun block ingredient, an exfoliating ingredient, a deodorizing ingredient, a shaving cream ingredient, a body wash ingredient, an anti-oxidant ingredient, and a fragrance ingredient, among others.

FIG. 4 is a diagram of an example of a housing (406) to receive a carrier (FIG. 1, 100) with additive compositions (FIG. 2, 204) disposed therein according to the principles described herein. As described above, the cleansing device also includes a housing (406) that receives the carrier (FIG. 1, 100). During use, additive compositions (FIG. 2, 204) are inserted into the carrier (FIG. 1, 100) which are inserted into the housing (406) to form a personal care product. The housing (406) may facilitate an enhanced and simplified application of the ingredients in the additive composition (FIG. 2, 204), and in some cases the ingredients in the carrier (FIG. 1, 100), to the skin. For example, given the material properties of the carrier (FIG. 1,100), during use in a wet environment such as a shower or bath, a carrier (FIG. 1, 100) itself may become slippery. Accordingly, a housing (406) can be formed such that it increases friction in a user's hand to facilitate ease of application of the compositions (FIG. 2, 204) to the user's skin.

Still further, the housing (406) may be formed of a material that enhances the deposition of the additive compositions (FIG. 2, 204) onto the surface. For example, the housing (406) may enhance a lather generated by the mixture of oxygen and the ingredients in the composition. The housing (406) may also increase the foam generation of the ingredients in the composition. For example, the housing (406) may be a loofah or a sponge that promote lather and/or foam formation which lather and/or foam increase the deposition of composition ingredients on the skin surface.

In another example, the housing (406) enhances deposition and application of the composition ingredients in other manners. For example, the housing (406) may have protrusions or other rough material to exfoliate the skin surface, which exfoliation allows particles to penetrate deeper onto the epidermis layer for a better cleansing effect. In some examples, the housing (406) is a wash cloth that exfoliates, promotes lather and foaming. The wash cloth may be ventilated such that additional quantities of the compositions are exposed to the skin surface. The housing (406) may also include other components such as texturized grips to facilitate handling, and nubs, or other protrusions to provide a massaging effect while in use.

The housing (406) is beneficial as it retains the carrier (FIG. 1, 100) and the additive compositions (FIG. 2, 204) in place whereas they otherwise may be prone to displacement.

The housing (406) also includes an opening (408) through which the carrier (FIG. 1, 100) and corresponding at least one additive composition (FIG. 2, 204) are inserted. For example, as depicted in FIG. 5, a carrier (100) with the additive compositions (204) are deposited in the housing (406) to be used in cleansing the skin surface of a user. The combination of the additive compositions (204) disposed in a carrier (100) which are both inserted into a housing (406) forms a personal care product application device that is used by a user to clean a surface such as a skin surface.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cleansing device comprising:
a carrier having at least one cavity defined therein, wherein:
the at least one cavity is to receive and maintain at least one additive composition; and
the at least one additive composition to be applied to a surface; and
a housing to hold the carrier during application of the additive composition to the surface.

2. The device of claim 1, wherein the housing facilitates increased lather during application of the additive composition to the surface.

3. The device of claim 1, wherein the housing is one of a sponge or a loofah.

4. The device of claim 1, wherein the housing comprises an opening through which the carrier and corresponding at least one additive composition are inserted into the housing.

5. The device of claim 1, wherein the housing is a ventilated wash cloth.

6. The device of claim 1, wherein the at least one additive composition is applied to a skin surface.

7. The device of claim 1, wherein the carrier is a bar soap.

8. The device of claim 1, wherein the carrier is made from at least one of a silicon material, a rubber material, a foam material, and a sponge material.

9. The device of claim 1, wherein the at least one cavity is a through hole in the carrier.

10. A cleansing system comprising:
a carrier having at least one cavity defined therein, wherein the at least one cavity is to receive and maintain at least one additive composition;
at least one additive composition disposed within a cavity of the carrier, wherein the additive composition is to be applied to a skin surface; and
a housing to house the carrier and the at least one additive composition during application of the composition onto the skin surface.

11. The cleansing system of claim 10, wherein the at least one additive composition is a semi-solid composition.

12. The cleansing system of claim 10, wherein the at least one additive composition is a soap composition.

13. The cleansing system of claim 10, wherein the at least one additive composition includes at least one personal care compound.

14. The cleansing system of claim 13, wherein the at least one personal care compound comprises a moisturizer, a lotion, an antibacterial compound, an acne treatment, a sun block compound, an exfoliating compound, a deodorizing compound, a shaving cream compound, a body wash compound, an anti-oxidant compound, and a fragrance compound.

15. The device of claim 13, wherein the antibacterial compound comprises at least one of triclosan, triclocarban, benzalkonium chloride, and benzethonium chloride.

16. The cleansing system of claim 13, wherein the at least one additive composition is the same shape and size as the at least one cavity.

17. The cleansing system of claim 13, comprising multiple and distinct types of additive composition.

18. The cleansing system of claim 13, wherein different additive compositions have different colors.

19. A personal care product application device comprising:
a bar soap having multiple cavities defined therein, wherein a cavity is to receive and maintain an additive personal care soap;
multiple additive personal care soaps, wherein an additive personal care soap is disposed within a cavity of the bar soap and is be applied to a skin surface; and
a housing to retain the bar soap and the multiple additive personal care soaps during application of the additive personal are soaps to the skin surface.

20. The device of claim 15, wherein an additive personal care soap includes a surfactant to cleanse the skin surface.
